(19) United States
(12) Patent Application Publication
(10) Pub. No.: US 2010/0027530 A1
(43) Pub. Date: Feb. 4, 2010

(54) ADAPTIVE NETWORK PHONE DEVICE AND CONTROL METHOD THEREOF

(76) Inventor: Wei-Ling Hsieh, (US)

Correspondence Address: SQUIRE, SANDERS & DEMPSEY L.L.P., 1 MARITIME PLAZA, SUITE 300, SAN FRANCISCO, CA, 94111, US

(21) Appl. No.: 12/277,143

(22) Filed: Nov. 24, 2008

(30) Foreign Application Priority Data
Aug. 4, 2008 (CN) 200810117743.1

(51) Int. Cl. H04L 12/66

(52) U.S. Cl. 370/352

(57) ABSTRACT

The present invention relates an adaptive network phone device and control method thereof, in which the adaptive network phone device includes: a storage unit adapted to store a virtual operating system, in which a VoIP software is carried; a control unit adapted to start automatically the virtual operating system and the VoIP software stored in the storage unit; and a voice conversion unit adapted to convert voice signals of senders into data packets and send the data packets to receivers by the Internet, and to convert data packets sent by the receivers into voice signals. The adaptive network phone device and control method thereof works with the network phones by the virtual operating system and the VoIP software carried in the virtual operating system on a computer without installing the VoIP software and the device driver.

### CROSS-REFERENCE TO RELATED APPLICATION

This application claims the priority benefit of China Patent Application No. 200810117743.1, filed on Aug. 4, 2008, entitled “Adaptive Network Phone Device and Control Method Thereof”. The content of the above identified application is incorporated herein by reference in its entirety.

### FIELD OF THE TECHNOLOGY

The present invention relates to a computer virtualization technical field, and particularly to an adaptive network phone device and control method thereof.

### BACKGROUND OF THE INVENTION

With a rapid development of science and technology, network phones are applied widely. The network phones are also known as Internet protocol (IP) phones, which transmit voice signal over Internet protocol. Traditional international phone calls are transmitted in a manner of analogy, and the voice signals are converted into analog signals, then the signals are sent to the other side through a copper cable. Network phones convert the voice signals into digital signals, then the digital signals are compressed into data packets, and finally, the data packets are sent to Internet; receivers decompress the data packets when they receive the data packets and convert the digital signals back into voice signals. At present, there are three different scenarios of the network phones, which are personal computer (PC) to PC, PC to phone, and phone to phone. The network phones use computer network, not the telecommunication network, to deliver signals, so it has to convert the voice signals of callers into the digital signals by a piece of special software. Since the fee of computer network is much lower than that of telecommunication network, it's getting popular everyday.

Making the network phone call on a computer shall necessarily use a piece of VoIP (Voice Over IP) software, an earphone, and a microphone. Integrating the VoIP software, the earphone, and the microphone into an external device which may connect with PCs by using a universal interface (such as a USB port) may make the use of the network phone more convenient to use. At present, the network phones with a USB port can only be used in PCs with both the device driver of the phone and the VoIP software (such as Skype) installed.

However, during implementing the technical solution mentioned above, the inventor finds that PCs need to install the VoIP software and the device driver; and computers without installing the VoIP software or the device driver can not work with the network phones, and only people with administrator's privilege can install the above software. Especially the device drivers are kernel-mode programs.

### SUMMARY OF THE INVENTION

Embodiment of the present invention provides an adaptive network phone device and control method thereof to work with network phones without the need of installing the VoIP software and the device driver on PCs.

An embodiment of the present invention provides an adaptive network phone device, and the device includes:

a storage unit adapted to store a virtual operating system, in which a piece of VoIP software is carried;

a control unit adapted to start automatically the virtual operating system and the VoIP software stored in the storage unit; and

a voice conversion unit adapted to convert voice signals of senders into digital data packets and send the data packets to receivers by the Internet, and to convert data packets sent by the receiver into voice signals.

An embodiment of the present invention provides an adaptive network phone control method, and the control method includes:

an adaptive network phone device is started after inserting the adaptive network phone device into a PC;

the adaptive network phone device runs automatically a virtual operating system and a piece of VoIP software;

a telephone number is dialed in the VoIP software on a keyboard and a network phone request is sent to receivers; and

a voice conversion unit, after the network phone request is received, converts data packets sent by the receivers into voice signals and sends the voice signals to senders, and converts voice signals of the senders into data packets and sends the data packets to the receivers.

The adaptive network phone device and control method thereof better work with the network phones without installing the VoIP software and the device driver by the virtual operating system and the VoIP software carried in the virtual operating system.

The present invention will be described in more detail with references to the drawings and embodiments.

### BRIEF DESCRIPTION OF THE DRAWINGS

FIG. 1 is a structure schematic view of an embodiment of a network phone device of the present invention; and

FIG. 2 is a flow chart of an embodiment of a network phone control method of the present invention.

### DETAILED DESCRIPTION OF THE PREFERRED EMBODIMENTS

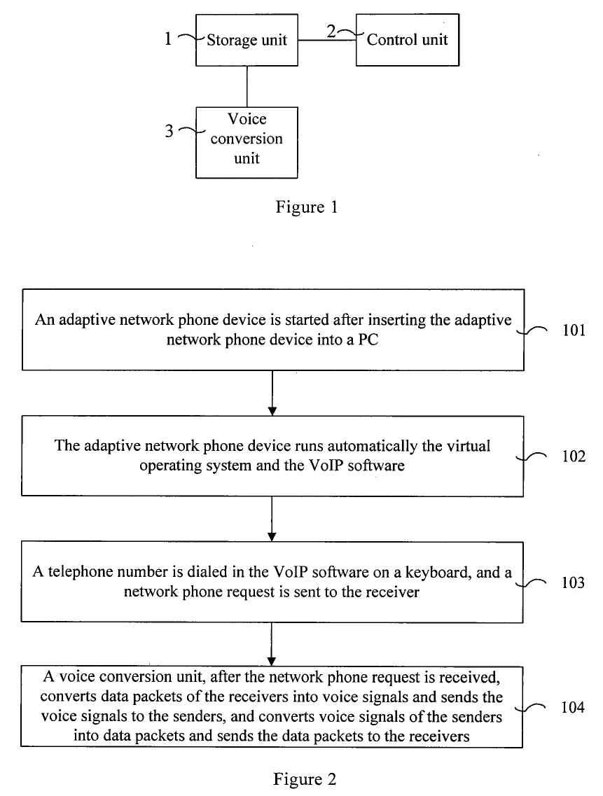

FIG. 1 is a structure schematic view of an embodiment of a network phone device of the present invention, and the device includes: a storage unit 1 adapted to store a virtual operating system, in which a piece of VoIP software is carried; a control unit 2 adapted to start automatically the virtual operating system and the VoIP software stored in the storage unit; and a voice conversion unit 3 adapted to convert voice signals of senders into data packets and send the data packets to receivers by the Internet, and to convert data packets sent by the receiver into voice signals and send the voice signals to the senders.

In which the VoIP software may be a instant messenger tool, such as Skype, Windows Live Messenger from Microsoft, or other similar software; and the adaptive network phone device may be any mobile storage device, such as a USB drive or a removable hard drive.

The process to realize the network phone with the adaptive device may be: a side sends a call request to the other side; the two sides start to communicate with each other.

The adaptive network phone device may make a low-priced or free network phone call through the virtual operating system stored therein and the VoIP software carried in the virtual operating system, which saves the phone fee and brings convenience to the user. The adaptive network phone device works with the network phone in user mode. In other words, the computer treat the virtual operating system as a general program library, and makes the VoIP program to invoke the virtual operating system, not to invoke the interface of the operating system directly; the virtual operating system takes over the application program interface of the computer to implement subsequent operations. Because the virtual operating system and VoIP programs do not need to be executed in kernel mode, the adaptive network phone device can be executed in any PC. Most public PCs only allow program to be executed in user mode to protect itself from being damaged. In addition, upgrading software installed in adaptive network phone devices is very easy, because it's basically a storage with phone functionality.

FIG. 2 is a flow chart of an embodiment of a network phone control method of the present invention, and the control method includes:

Step 101: An adaptive network phone device is started after inserting the adaptive network phone device into a PC;

a user himself starts the VoIP software of the virtual operating system after inserting the adaptive network phone device into the PC; or the PC identifies automatically an automatic execution file and starts the VoIP software corresponding to the automatic execution file. For example, the user may start the VoIP software carried in the virtual operating system by double clicking its icon; and the PC may identify the adaptive network phone device as a compact disc and start the VoIP software of the virtual operating system;

Step 102: The adaptive network phone device runs automatically the virtual operating system and the VoIP software;

the adaptive network phone device runs automatically the virtual operating system and the VoIP software stored therein; the virtual operating system takes over the interface between OS and the VoIP software. According to the profile and program files of the VoIP software carried in the virtual operating system; the profile may include corresponding modifications of the registry system and environment variables and a corresponding relationship of files; and the program files include all files required when the VoIP software runs;

Step 103: A telephone number is dialed in the VoIP software on a keyboard, and a network phone request is sent to the receiver;

the senders may send the network phone request to the receivers on the keyboard after the VoIP software starts; and

Step 104: A voice conversion unit, after the network phone request is received, converts data packets of the receivers into voice signals and sends the voice signals to the senders, and converts voice signals of the senders into data packets and sends the data packets to the receivers.

Both sides start to call after the network phone request is received by the receivers; the voice conversion unit stored in the adaptive network phone device receives the data packets sent by the receivers and converts the data packets of the receivers into voice signals and sends the voice signals to the senders, at the same time, reads voice signals of the senders, converts the voice signals of the senders into data packets and sends the data packets to the receivers. It is noticeable that both the senders and the receivers are relative, the receivers become the senders when the senders send back information after the receivers receive the voice signals sent by the senders, so the description should not lead to ambiguity.

The function of the network phone is realized in user mode. In other words, the computer in the user mode treats the virtual operating system as a general program library and invokes the virtual operating system, and does not invoke the interface of the operating system directly; and the virtual operating system takes over the application program interface of the computer to implement subsequent operations.

The adaptive network phone control method may make a low-priced or free network phone call through the virtual operating system stored in the adaptive network phone device and the VoIP software carried in the virtual operating system, which saves the phone fee and brings convenience to the user. Because the virtual operating system and VoIP programs do not need to be executed in kernel mode, the adaptive network phone device can be executed in any PC. Most public PCs only allow program to be executed in user mode to protect itself from being damaged.

Though illustration and description of the present disclosure have been given with reference to the embodiments thereof, it should be appreciated by persons of ordinary skill in the art that various changes in forms and details can be made without deviation from the spirit and scope of this disclosure, which are defined by the appended claims.

What is claimed is:

1. An adaptive network phone device, comprising:
a storage unit adapted to store a virtual operating system, in which a piece of voice over Internet protocol (VoIP) software is carried;
a control unit adapted to start automatically the virtual operating system and the VoIP software stored in the storage unit; and
a voice conversion unit adapted to convert voice signals of senders into digital data packets and send the data packets to receivers by the Internet, and to convert data packets sent by the receivers into voice signals.

2. The adaptive network phone device according to claim 1, wherein the VoIP software is Skype or Windows Live Messenger from Microsoft.

3. The adaptive network phone device according to claim 1, wherein the adaptive network phone device is a universal serial bus (USB) drive or a removable hard drive.

4. The adaptive network phone device according to claim 2, wherein the adaptive network phone device is a universal serial bus (USB) drive or a removable hard drive.

5. An adaptive network phone control method, comprising:
starting an adaptive network phone device after inserting the adaptive network phone device into a personal computer (PC);
the adaptive network phone device running automatically a virtual operating system and a piece of voice over Internet protocol (VoIP) software;
dialing a telephone number in the VoIP software on a keyboard and sending a network phone request to receivers; and
a voice conversion unit, after the network phone request is received, conversion data packets sent by the receivers into voice signals and sending the voice signals to senders, and converting voice signals of the senders into data packets and sending the data packets to the receivers.

6. The method according to claim 5, wherein the step of the adaptive network phone device running automatically a virtual operating system and a VoIP software comprises:
the adaptive network phone device running automatically the virtual operating system; and the virtual operating system taking over an application program interface of the PC and starting automatically the VoIP software according to a configuration file and a program file of the VoIP software carried in the virtual operating system.

7. The method according to claim 5, wherein the step of the starting an adaptive network phone device after inserting the adaptive network phone device into a PC comprises:
a user himself starting the VoIP software of the virtual operating system after inserting the adaptive network phone device into the PC; or
the PC identifying automatically an automatic execution file and starting the VoIP software corresponding to the automatic execution file.

8. The method according to claim 6, wherein the step of the starting an adaptive network phone device after inserting the adaptive network phone device into a PC comprises:
a user himself starting the VoIP software of the virtual operating system after inserting the adaptive network phone device into the PC; or
the PC identifying automatically an automatic execution file and starting the VoIP software corresponding to the automatic execution file.

9. The method according to claim 6, wherein the configuration file comprises a corresponding relationship of a registry and a corresponding relationship of files; and the program file comprises all files required when the VoIP software runs.
